(19) United States
(12) Patent Application Publication
(10) Pub. No.: US 2014/0208572 A1
(43) Pub. Date: Jul. 31, 2014

(54) ELASTIC INSERT ALIGNMENT ASSEMBLY AND METHOD OF REDUCING POSITIONAL VARIATION

(71) Applicant: GM GLOBAL TECHNOLOGY OPERATIONS LLC, Detroit, MI (US)

(72) Inventors: Joel Colombo, Howell, MI (US); Michael D. Richardson, Troy, MI (US)

(73) Assignee: GM GLOBAL TECHNOLOGY OPERATIONS LLC, Detroit, MI (US)

(21) Appl. No.: 13/752,449

(22) Filed: Jan. 29, 2013

(51) Int. Cl. F16B 17/00

(52) U.S. Cl. CPC F16B 17/00
USPC 29/505; 403/280

(57) ABSTRACT

An elastic insert assembly for aligning components to each other includes a first component having a first surface and a second surface. Also included is a second component. Further included is a pocket portion of the second component configured to receive the first component therein, the pocket portion defined by at least one sidewall and a base wall, wherein the at least one sidewall extends from the base wall in an angularly outward direction. Yet further included is at least one elastically deformable perimeter wall of the first component, the at least one elastically deformable perimeter wall tapered inwardly from the first surface to the second surface, the at least one elastically deformable perimeter wall formed of an elastically deformable material to elastically deform at an interface between the at least one elastically deformable perimeter wall and the at least one sidewall.

### FIELD OF THE INVENTION

The present invention relates to an elastic insert alignment assembly for aligning components relative to each other, as well as a method of reducing positional variation for components of the elastic insert alignment assembly.

### BACKGROUND

Currently, components which are to be mated together in a manufacturing process are subject to positional variation based on the mating arrangements between the components. One common arrangement includes components mutually located with respect to each other by 2-way and/or 4-way male alignment features, typically upstanding bosses, which are received into corresponding female alignment features, typically apertures in the form of holes or slots. Alternatively, adhesives or welding processes may be employed to mate parts. Irrespective of the precise mating arrangement, there is a clearance between at least a portion of the mated components which is predetermined to match anticipated size and positional variation tolerances of the mating features as a result of manufacturing (or fabrication) variances. As a result, occurrence of significant positional variation between the mated components may contribute to the presence of undesirably large and varying gaps and otherwise poor fit.

### SUMMARY OF THE INVENTION

In one exemplary embodiment, an elastic insert assembly for aligning components to each other includes a first component having a first surface and a second surface. Also included is a second component. Further included is a pocket portion of the second component configured to receive the first component therein, the pocket portion defined by at least one sidewall and a base wall, wherein the at least one sidewall extends from the base wall in an angularly outward direction. Yet further included is at least one elastically deformable perimeter wall of the first component, the at least one elastically deformable perimeter wall tapered inwardly from the first surface to the second surface, the at least one elastically deformable perimeter wall formed of an elastically deformable material to elastically deform at an interface between the at least one elastically deformable perimeter wall and the at least one sidewall.

In another exemplary embodiment, an elastic insert assembly for aligning components to each other includes a first component having a first surface and a second surface. Also included is a second component. Further included is a pocket portion of the second component configured to receive the first component therein, the pocket portion defined by at least one sidewall and a base wall, wherein the at least one sidewall extends from the base wall in an angularly outward direction. Yet further included is at least one perimeter wall of the first component, the at least one perimeter wall tapered inwardly from the first surface to the second surface, at least one of the at least one sidewall and the at least one perimeter wall formed of an elastically deformable material to elastically deform at an interface between the at least one perimeter wall and the at least one sidewall.

In yet another exemplary embodiment, a method of reducing positional variation of an elastic insert alignment assembly includes inserting a first component into a pocket portion of a second component. The method also includes engaging at least one elastically deformable perimeter wall of the first component with at least one sidewall of the pocket portion of the second component, wherein the at least one elastically deformable perimeter wall tapers inwardly from a first surface of the first component to a second surface of the first component, and wherein the at least one sidewall extends from a base wall of the pocket portion in an angularly outward direction. The method further includes performing an elastic averaging of the elastic deformation over the at least one elastically deformable perimeter wall, wherein upon engagement of the at least one elastically deformable perimeter wall with the at least one sidewall, a fitted alignment between the first component and the second component is established.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a front elevation view of a first component of an elastic insert alignment assembly;

FIG. 2 is a front elevation view of the elastic insert alignment assembly comprising the first component, illustrating the first component disposed within a second component;

FIG. 3 is a cross-sectional view of the elastic insert alignment assembly prior to insertion of the first component into the second component taken at line 3-3 of FIG. 2;

FIG. 4 is a cross-sectional view of the first component inserted into, and engaged with, the second component taken at line 4-4 of FIG. 2; and

FIG. 5 is a flow diagram illustrating a method of reducing positional variation of the elastic insert alignment assembly.

### DESCRIPTION OF THE EMBODIMENTS

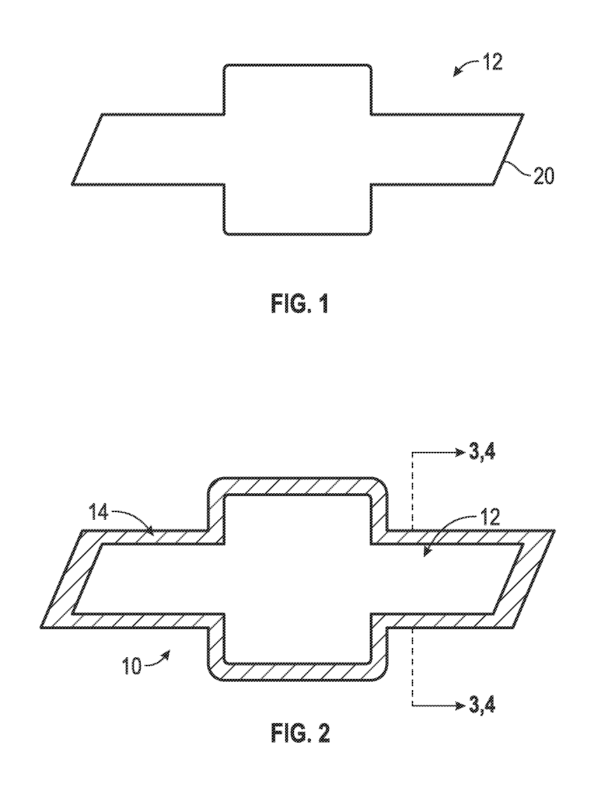

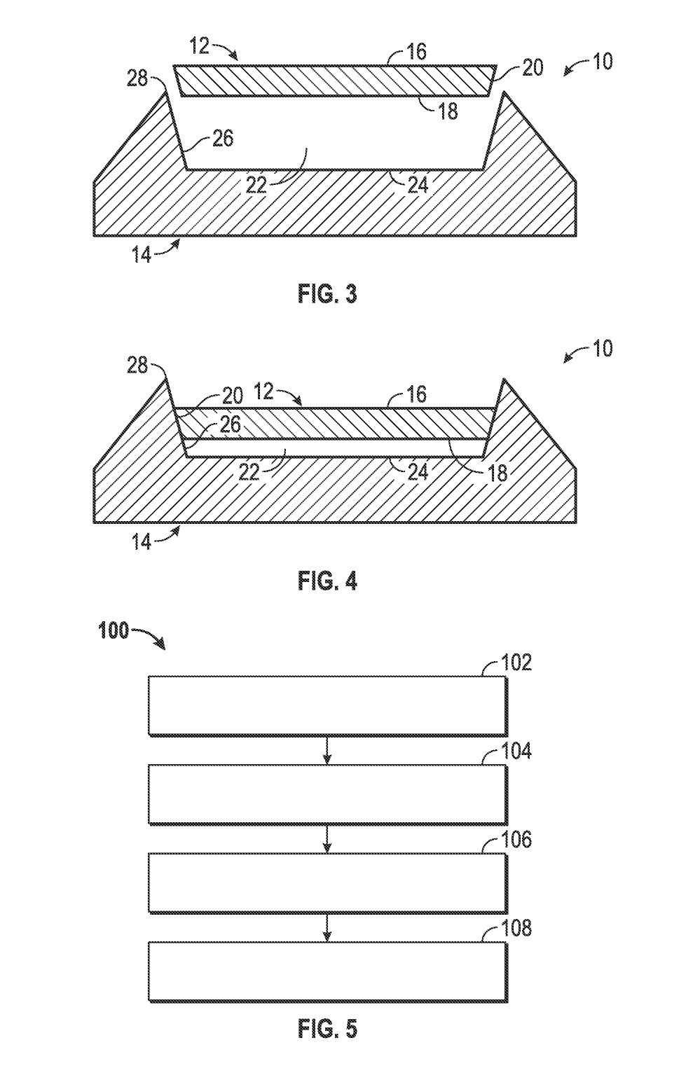

Referring to FIGS. 1-4, an elastic insert alignment assembly 10 is illustrated. The elastic insert alignment assembly 10 comprises a first component 12 and a second component 14 that are disposed in a mated configuration with respect to each other. It is to be appreciated that the elastic insert alignment assembly 10 is to be employed for securely fitting components, such as the first component 12 and the second component 14, to each other, while also providing a self-aligning relationship between the components upon interaction of the components with each other. In one embodiment, the elastic insert alignment assembly 10 is used in conjunction with a vehicle application, such as a vehicle emblem, however, it is to be understood that the elastic insert alignment assembly 10, as described herein, may be used to efficiently mate components associated with numerous other applications. In an exemplary embodiment such as a vehicle emblem for an automobile, the first component 12 comprises an insert and the second component 14 comprises a bezel for receiving the insert.

Although illustrated in a specific geometry, the first component 12 and the second component 14 may be configured in countless geometries. Irrespective of the precise geometry of the first component 12 and the second component 14, the second component 14 is configured to fittingly receive the first component 12 within a portion of the second component 14, which will be described in detail below.

The first component 12 includes a first surface 16 and a second surface 18 that are typically planar surfaces spaced from one another and arranged in planes relatively parallel to each other. In an alternative embodiment, the first surface 16 and the second surface 18 are curvilinear, rather than planar and are merely spaced from one another. Regardless of the precise geometry of the first surface 16 and the second surface 18, the first surface 16 and the second surface 18 are connected along a perimeter of the first component 12 by at least one perimeter wall 20. In the illustrated embodiment, the at least one perimeter wall 20 includes a plurality of segments or individual walls, but is referred to herein as the at least one perimeter wall 20. The at least one perimeter wall 20 is tapered inwardly as the at least one perimeter wall 20 extends from the first surface 16 to the second surface 18 of the first component 12, such that the second surface 18 comprises a smaller area than the first surface 16. The tapering of the at least one perimeter wall 20 is typically in a planar alignment, such that the at least one perimeter wall 20 is substantially flat.

The second component 14 is any component that is configured to mate with the first component 12 by at least partially receiving the first component 12 within a pocket portion 22 of the second component 14. The pocket portion 22 of the second component 14 is defined by a base wall 24 and at least one sidewall 26 extending away from the base wall 24. In one embodiment, the base wall 24 is substantially planar (e.g., substantially flat), but it is contemplated that the base wall 24 comprises a degree of curvature. As the at least one sidewall 26 extends away from the base wall 24, the at least one sidewall 26 tapers outwardly, thereby providing the pocket portion 22 with a progressively narrowed opening, with respect to an outermost position 28 of the at least one sidewall 26 to the base wall 24. Similar to the at least one perimeter wall 20, in the illustrated embodiment, the at least one sidewall 26 includes a plurality of segments or individual walls, but is referred to herein as the at least one sidewall 26. Both of the at least one perimeter wall 20 and the at least one sidewall 26 may be considered a single, continuous wall or may be segmented into a plurality of walls, but regardless of the precise configuration, the at least one perimeter wall 20 and the at least one sidewall 26 extend in continuous paths to form an enclosing perimeter for the first component 12 and the pocket portion 22, respectively.

As described above, the at least one perimeter wall 20 tapers in what is characterized as an inward orientation, while the at least one sidewall 26 tapers in what is characterized as an outward orientation. As shown, the angles of inclination of the at least one perimeter wall 20 and the at least one sidewall 26 substantially correspond to one another, however, based on manufacturing variability it is contemplated that the angles of inclination do not necessarily equate to one another.

The first component 12 is positioned and fittingly engaged within the pocket portion 22 of the second component 14 upon translation of the first component 12 toward the base wall 24. The at least one perimeter wall 20 engages the at least one sidewall 26 such that the second surface 18 is at a position spaced from the base wall 24 within the pocket portion 22. Subsequent translation of the first component 12 toward the base wall 24 results in an elastic deformation at an interface between the at least one perimeter wall 20 and the at least one sidewall 26. In one embodiment, elastic deformation of only the at least one perimeter wall 20 occurs in response to resistance imposed on the at least one perimeter wall 20 by the at least one sidewall 26. Alternatively, elastic deformation of only the at least one sidewall 26 occurs in response to resistance imposed on the at least one sidewall 26 by the at least one perimeter wall 20. It is further contemplated that both the at least one perimeter wall 20 and the at least one sidewall 26 occurs.

Any suitable elastically deformable material may be used for the first component 12 and/or the second component 14. More specifically, elastically deformable material is disposed proximate, or integral to, the at least one perimeter wall 20 and/or the at least one sidewall 26. This includes various metals, polymers, ceramics, inorganic materials or glasses, or composites of any of the aforementioned materials, or any other combinations thereof. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS), such as an ABS acrylic. The material may be in any form and formed or manufactured by any suitable process, including stamped or formed metal, composite or other sheets, forgings, extruded parts, pressed parts, castings, or molded parts and the like, to include the deformable features described herein. The material, or materials, may be selected to provide a predetermined elastic response characteristic of either or both of the at least one perimeter wall 20 and the at least one sidewall 26. The predetermined elastic response characteristic may include, for example, a predetermined elastic modulus.

In an exemplary embodiment, the first component 12 comprises an ABS acrylic that is elastically deformable, that is to say that at least a portion of the first component 12 is configured to elastically deform and resiliently return to an original shape, while the second component 14 comprises a chrome-plated ABS.

The precise position where engagement between the at least one perimeter wall 20 and the at least one sidewall 26 occurs will vary depending on positional variance imposed by manufacturing factors. Due to the elastically deformable properties of the elastic material comprising the at least one perimeter wall 20 and/or the at least one sidewall 26, the criticality of the initial location of engagement is reduced. Further insertion of the first component 12 into the pocket portion 22 of the second component 14 toward the base wall 24 ultimately leads to a fully engaged position of the first component 12, as illustrated best in FIG. 4. The sizes of the first component 12 and the second component 14, as well as the elastic properties of the elastic material(s), result in the fully engaged position typically being located in a spaced relationship to the base wall 24, but it is contemplated that contact occurs between the second surface 18 of the first component 12 and the base wall 24 of the second component 14.

Irrespective of the precise location of the fully engaged position, a tight, fitted engagement between the at least one perimeter wall 20 and the at least one sidewall 26 is achieved by frictional forces present at the interface between the at least one perimeter wall 20 and the at least one sidewall 26. Such a condition is ensured by sizing the second surface 18 of the first component 12 to be larger than the base wall 24 of the second component 14. Specifically, the second surface 18 comprises an area larger than that of an area of the base wall 24. The interference between the at least one perimeter wall 20 and the at least one sidewall 26 causes elastic deformation proximate the contacted surfaces and insertion of the first component 12 continues until a substantial majority or the entire perimeter of the at least one perimeter wall 20 is in contact with the at least one sidewall 26. The malleability of the materials reduces issues associated with positional variance. More particularly, in contrast to a rigid insert that typically results in gaps between the insert and receiving structure at portions around the perimeter of the insert, the first component 12 advantageously deforms until a substantial majority or the entire perimeter is in contact with the pocket portion 22, thereby reducing or eliminating gaps associated with manufacturing challenges.

The elastic deformation of the at least one perimeter wall 20 elastically averages any positional errors between the first component 12 and the second component 14. In other words, gaps that would otherwise be present due to positional errors associated with portions or segments of the at least one perimeter wall 20 and the at least one sidewall 26 are eliminated by offsetting the gaps with an over-constrained condition along other portions or segments of the at least one perimeter wall 20 and the at least one sidewall 26. The principles of elastic averaging are described in detail in commonly owned, co-pending U.S. patent application Ser. No. 13/187,675, the disclosure of which is incorporated by reference herein in its entirety.

A method of reducing positional variation of an elastic insert alignment assembly 100 is also provided, as illustrated in FIG. 5, and with reference to FIGS. 1-4. The elastic insert alignment assembly 10, and more specifically the elastically deformable nature of the first component 12 and/or the second component 14 have been previously described and specific structural components need not be described in further detail. The method of reducing positional variation of an elastic insert alignment assembly 100 includes inserting 102 the first component 12 into the pocket portion 22 of the second component 14. The method also includes engaging 104 the at least one perimeter wall 20 of the first component 12 with the at least one sidewall 26 of the pocket portion 22 of the second component 14. The method further includes elastically deforming 106 the at least one perimeter wall 20 upon engagement with the at least one sidewall 26. The method yet further includes performing an elastic averaging of the elastic deformation 108 over the at least one perimeter wall 20.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastic insert alignment assembly for aligning components to each other comprising:
a first component having a first surface and a second surface;
a second component;
a pocket portion of the second component configured to receive the first component therein, the pocket portion defined by at least one sidewall and a base wall, wherein the at least one sidewall extends from the base wall in an angularly outward direction; and
at least one elastically deformable perimeter wall of the first component, the at least one elastically deformable perimeter wall tapered inwardly from the first surface to the second surface, the at least one elastically deformable perimeter wall formed of an elastically deformable material to elastically deform at an interface between the at least one elastically deformable perimeter wall and the at least one sidewall.

2. The elastic insert alignment assembly of claim 1, the base wall comprising a first area and the second surface of the first component comprising a second area, wherein the second area is greater than the first area.

3. The elastic insert alignment assembly of claim 1, wherein the at least one sidewall and the at least one elastically deformable perimeter wall are substantially flat.

4. The elastic insert alignment assembly of claim 1, wherein the first component comprises an ABS acrylic material.

5. The elastic insert alignment assembly of claim 1, wherein the second component comprises a chrome-plated ABS material.

6. The elastic insert alignment assembly of claim 1, further comprising a fully engaged position of the first component, wherein the fully engaged position comprises contact between the at least one sidewall and the at least one elastically deformable perimeter wall along substantially an entirety of the at least one elastically deformable perimeter wall.

7. The elastic insert alignment assembly of claim 1, wherein the first component comprises an insert and the second component comprises a bezel.

8. The elastic insert alignment assembly of claim 1, wherein the first component and the second component comprise a vehicle emblem when the first component is disposed in a fully engaged position with the second component.

9. The elastic insert alignment assembly of claim 1, wherein the at least one elastically deformable perimeter wall comprises a plurality of elastically deformable perimeter walls defining a perimeter of the first component.

10. The elastic insert alignment assembly of claim 1, wherein the at least one sidewall comprises a plurality of sidewalls.

11. An elastic insert alignment assembly for aligning components to each other comprising:
a first component having a first surface and a second surface;
a second component;
a pocket portion of the second component configured to receive the first component therein, the pocket portion defined by at least one sidewall and a base wall, wherein the at least one sidewall extends from the base wall in an angularly outward direction; and
at least one perimeter wall of the first component, the at least one perimeter wall tapered inwardly from the first surface to the second surface, at least one of the at least one sidewall and the at least one perimeter wall formed of an elastically deformable material to elastically deform at an interface between the at least one perimeter wall and the at least one sidewall.

12. The elastic insert alignment assembly of claim 11, the base wall comprising a first area and the second surface of the first component comprising a second area, wherein the second area is greater than the first area.

13. The elastic insert alignment assembly of claim 11, wherein the at least one sidewall and the at least one perimeter wall are substantially flat.

14. The elastic insert alignment assembly of claim 11, further comprising a fully engaged position of the first component, wherein the fully engaged position comprises contact between the at least one sidewall and the at least one perimeter wall along substantially an entirety of the at least one perimeter wall.

15. The elastic insert alignment assembly of claim 11, wherein the first component comprises an insert and the second component comprises a bezel.

16. The elastic insert alignment assembly of claim 11, wherein the first component and the second component comprise a vehicle emblem when the first component is disposed in a fully engaged position with the second component.

17. The elastic insert alignment assembly of claim 11, wherein the at least one perimeter wall comprises a plurality of elastically deformable perimeter walls defining a perimeter of the first component.

18. A method of reducing positional variation of an elastic insert alignment assembly comprising:
inserting a first component into a pocket portion of a second component;
engaging at least one elastically deformable perimeter wall of the first component with at least one sidewall of the pocket portion of the second component, wherein the at least one elastically deformable perimeter wall tapers inwardly from a first surface of the first component to a second surface of the first component, and wherein the at least one sidewall extends from a base wall of the pocket portion in an angularly outward direction;
elastically deforming the at least one elastically deformable perimeter wall upon engagement of the at least one elastically deformable perimeter wall with the at least one sidewall; and
performing an elastic averaging of the elastic deformation over the at least one elastically deformable perimeter wall, wherein upon engagement of the at least one elastically deformable perimeter wall with the at least one sidewall, a fitted alignment between the first component and the second component is established.

19. The method of claim 18, further comprising inserting the first component into the pocket portion of the second component until the first component reaches a fully engaged position, wherein the fully engaged position comprises contact between the at least one sidewall and the at least one elastically deformable perimeter wall along an entirety of the at least one elastically deformable perimeter wall.

20. The method of claim 18, wherein performing the elastic averaging comprises elastically averaging the elastic deformation over a plurality of elastically deformable perimeter walls.
